(19) United States
(12) Patent Application Publication
(10) Pub. No.: US 2022/0214752 A1
(43) Pub. Date: Jul. 7, 2022

(54) GESTURE-BASED TARGETING CONTROL FOR IMAGE CAPTURE DEVICES

(71) Applicant: GoPro, Inc., San Mateo, CA (US)

(72) Inventors: Maxim Karpushin, Paris (FR); Balthazar Neveu, Issy les Moulineaux (FR); Thomas Veit, Meudon (FR); Nicolas Rahmouni, San Mateo, CA (US)

(21) Appl. No.: 17/129,381

(22) Filed: Dec. 21, 2020

(51) Int. Cl. G06F 3/01; H04N 5/232; G06F 3/16

(52) U.S. Cl. CPC G06F 3/017; H04N 5/23203; H04N 5/23219; H04N 5/232935; H04N 5/232127; G06F 3/167; H04N 5/23216

(57) ABSTRACT

An image capture device may capture visual content depicting a hand gesture. The hand gesture may identify a subject to be targeted by the image capture device. The targeting of the image capture device (e.g., for stabilization, for focusing) may be changed to be directed at the subject identified by the hand gesture. The image capture device may persistently target the subject identified by the hand gesture for future capture of visual content.

### FIELD

This disclosure relates to changing targeting of an image capture device based on gestures.

### BACKGROUND

Selecting a target of an image capture device may require a user to physical interact with the image capture device, such as by pressing a button or tapping on a touchscreen of the image capture device. Such physical interaction with the image capture device may be cumbersome, difficult, and/or cause undesired movement of the image capture device.

### SUMMARY

This disclosure relates to changing targeting of an image capture device based on gestures. An image capture device may capture visual content during a capture duration. A target gesture may be detected within the visual content. The target gesture may identify a subject to be targeted by the image capture device within the visual content. Responsive to detection of the target gesture within the visual content, targeting of the image capture device for future capture of the visual content may be changed to be directed at the subject identified by the target gesture.

A system that changes targeting of an image capture device based on gestures may include one or more electronic storages, one or more processors, and/or other components. An electronic storage may store visual information, information relating to visual content, information relating to image capture device, information relating to target of image capture device, information relating to target gesture, information relating to subject to be targeted by image capture device, and/or other information. In some implementations, the system may include one or more optical elements, one or more image sensors, one or more displays, and/or other components.

One or more components of the system may be carried by a housing, such as a housing of an image capture device. For example, the optical element(s), the image sensor(s), and/or the display(s) of the system may be carried by a housing of an image capture device. An optical element may be configured to guide light within a field of view to an image sensor. An image sensor may be configured to generate a visual output signal conveying visual information based on light that becomes incident thereon and/or other information. The visual information may define visual content. The housing may carry other components, such as the display(s), processor(s), and/or the electronic storage.

The processor(s) may be configured by machine-readable instructions. Executing the machine-readable instructions may cause the processor(s) to facilitate changing targeting of an image capture device based on gestures. The machine-readable instructions may include one or more computer program components. The computer program components may include one or more of a capture component, a target gesture component, a target component, and/or other computer program components.

The capture component may be configured to capture the visual content. The visual content may be captured during one or more capture durations.

The target gesture component may be configured to detect a target gesture within the visual content. A target gesture may identify a subject to be targeted by the image capture device within the visual content. In some implementations, the target gesture within the visual content may be detected based on voice activation of a gesture target mode of the image capture device and/or other information.

In some implementations, the target gesture may include one or more pointing fingers. The subject may be identified based on a direction in which the pointing finger(s) are pointed.

In some implementations, the target gesture may include bounding fingers. The subject may be identified based on a portion of the visual content bounded by the bounding fingers.

In some implementations, the target gesture includes movement of one or more fingers to trace a shape. The subject may be identified based on a portion of the visual content bounded by the shape.

The target component may be configured to, responsive to detection of the target gesture within the visual content, change targeting of the image capture device for future capture of the visual content. The targeting of the image capture device may be changed to be directed at the subject identified by the target gesture. In some implementations, the targeting of the image capture device may be changed without physical interaction of a user with the image capture device.

In some implementations, the change in the targeting of the image capture device for future capture of the visual content to be directed at the subject identified by the target gesture may include setting the subject identified by the target gesture as a stabilization target for the future capture of the visual content.

In some implementations, the change in the targeting of the image capture device for future capture of the visual content to be directed at the subject identified by the target gesture may include setting the subject identified by the target gesture as a focus target for the future capture of the visual content.

In some implementations, the image capture device may further comprise a display. A preview of the change in the targeting of the image capture device for future capture of the visual content to be directed at the subject identified by the target gesture may be presented on the display prior to the change in the targeting of the image capture device. In some implementations, cancellation of the change in the targeting of the image capture device for future capture of the visual content to be directed at the subject identified by the target gesture may be receivable via user interaction with the image capture device.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system that changes targeting of an image capture device based on gestures.

FIG. 2 illustrates an example method for changing targeting of an image capture device based on gestures.

FIG. 3 illustrates an example image capture device.

FIGS. 4A, 4B, 4C, and 4D illustrate example target gestures.

### DETAILED DESCRIPTION

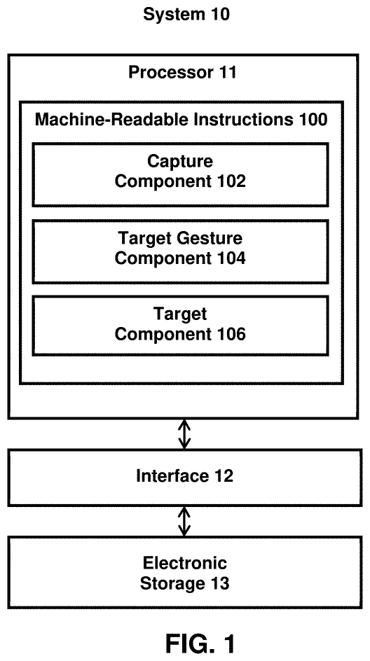

FIG. 1 illustrates a system 10 for changing targeting of an image capture device based on gestures. The system 10 may include one or more of a processor 11, an interface 12 (e.g., bus, wireless interface), an electronic storage 13, and/or other components. In some implementations, the system 10 may include one or more optical elements, one or more image sensors, one or more displays, and/or other components. The system 10 may include and/or be part of an image capture device. The image capture device may include a housing, and one or more of the optical element(s), the image sensor(s), the display(s), the processor 11, and/or other components of the system 10 may be carried by the housing the image capture device. An optical element may guide light within a field of view to an image sensor. An image sensor may generate a visual output signal conveying visual information defining visual content based on light that becomes incident thereon. The processor 11 may capture visual content during a capture duration. A target gesture may be detected within the visual content by the processor 11. The target gesture may identify a subject to be targeted by the image capture device within the visual content. Responsive to detection of the target gesture within the visual content, targeting of the image capture device for future capture of the visual content may be changed by the processor 11 to be directed at the subject identified by the target gesture.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store visual information, information relating to visual content, information relating to image capture device, information relating to target of image capture device, information relating to target gesture, information relating to subject to be targeted by image capture device, and/or other information.

The system 10 may be remote from the image capture device or local to the image capture device. One or more portions of the image capture device may be remote from or a part of the system 10. One or more portions of the system 10 may be remote from or a part of the image capture device. For example, one or more components of the system 10 may be carried by a housing, such as a housing of an image capture device. For instance, processor(s), optical element(s), image sensor(s), and/or display(s) of the system 10 may be carried by the housing of the image capture device. The housing may carry other components, such as the processor 11 and/or the electronic storage 13.

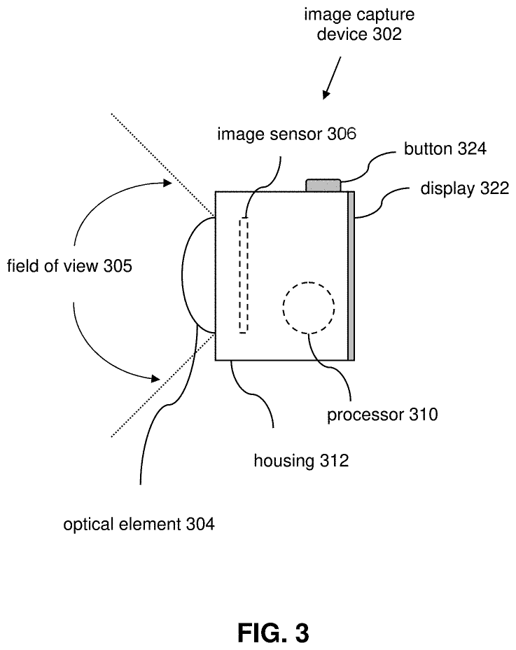

An image capture device may refer to a device for recording visual information in the form of images, videos, and/or other media. An image capture device may be a standalone device (e.g., camera, action camera, image sensor) or may be part of another device (e.g., part of a smartphone, tablet). FIG. 3 illustrates an example image capture device 302. Visual content (e.g., of image(s), video frame(s)) may be captured by the image capture device 302. The image capture device 302 may include a housing 312. The housing 312 may refer a device (e.g., casing, shell) that covers, protects, and/or supports one or more components of the image capture device 302. The housing 312 may include a single-piece housing or a multi-piece housing. The housing 312 may carry (be attached to, support, hold, and/or otherwise carry) an optical element 304, an image sensor 306, a processor 310, a display 322, a button 324, and/or other components. One or more components of the image capture device 302 may be the same as, be similar to, and/or correspond to one or more components of the system 10. Other configurations of image capture devices are contemplated.

The optical element 304 may include instrument(s), tool(s), and/or medium that acts upon light passing through the instrument(s)/tool(s)/medium. For example, the optical element 304 may include one or more of lens, mirror, prism, and/or other optical elements. The optical element 304 may affect direction, deviation, and/or path of the light passing through the optical element 304. The optical element 304 may have a field of view 305. The optical element 304 may be configured to guide light within the field of view 305 to the image sensor 306.

The field of view 305 may include the field of view of a scene that is within the field of view of the optical element 304 and/or the field of view of the scene that is delivered to the image sensor 306. For example, the optical element 304 may guide light within its field of view to the image sensor 306 or may guide light within a portion of its field of view to the image sensor 306. The field of view 305 of the optical element 304 may refer to the extent of the observable world that is seen through the optical element 304. The field of view 305 of the optical element 304 may include one or more angles (e.g., vertical angle, horizontal angle, diagonal angle) at which light is received and passed on by the optical element 304 to the image sensor 306. In some implementations, the field of view 305 may be greater than 180-degrees. In some implementations, the field of view 305 may be less than 180-degrees. In some implementations, the field of view 305 may be equal to 180-degrees.

In some implementations, the image capture device 302 may include multiple optical elements. For example, the image capture device 302 may include multiple optical elements that are arranged on the housing 312 to capture spherical images/videos (guide light within spherical field of view to one or more images sensors). For instance, the image capture device 302 may include two optical elements positioned on opposing sides of the housing 312. The fields of views of the optical elements may overlap and enable capture of spherical images and/or spherical videos.

The image sensor 306 may include sensor(s) that converts received light into output signals. The output signals may include electrical signals. The image sensor 306 may generate output signals conveying information that defines visual content of one or more images and/or one or more video frames of a video. For example, the image sensor 306 may include one or more of a charge-coupled device sensor, an active pixel sensor, a complementary metal-oxide semiconductor sensor, an N-type metal-oxide-semiconductor sensor, and/or other image sensors.

The image sensor 306 may be configured generate output signals conveying information that defines visual content of one or more images and/or one or more video frames of a video. The image sensor 306 may be configured to generate a visual output signal based on light that becomes incident thereon during a capture duration and/or other information. The visual output signal may convey visual information that defines visual content having the field of view. The optical element 304 may be configured to guide light within the field of view 305 to the image sensor 306, and the image sensor 306 may be configured to generate visual output signals conveying visual information based on light that becomes incident thereon via the optical element 304.

Visual content may refer to content of image(s), video frame(s), and/or video(s) that may be consumed visually. For example, visual content may be included within one or more images and/or one or more video frames of a video. The video frame(s) may define/contain the visual content of the video. That is, video may include video frame(s) that define/contain the visual content of the video. Video frame(s) may define/contain visual content viewable as a function of progress through the progress length of the video content. A video frame may include an image of the video content at a moment within the progress length of the video. As used herein, term video frame may be used to refer to one or more of an image frame, frame of pixels, encoded frame (e.g., I-frame, P-frame, B-frame), and/or other types of video frame. Visual content may be generated based on light received within a field of view of a single image sensor or within fields of view of multiple image sensors.

Visual content (of image(s), of video frame(s), of video(s)) with a field of view may be captured by an image capture device during a capture duration. A field of view of visual content may define a field of view of a scene captured within the visual content. A capture duration may be measured/defined in terms of time durations and/or frame numbers. For example, visual content may be captured during a capture duration of 60 seconds, and/or from one point in time to another point in time. As another example, 1800 images may be captured during a capture duration. If the images are captured at 30 images/second, then the capture duration may correspond to 60 seconds. Other capture durations are contemplated.

Visual content may be stored in one or more formats and/or one or more containers. A format may refer to one or more ways in which the information defining visual content is arranged/laid out (e.g., file format). A container may refer to one or more ways in which information defining visual content is arranged/laid out in association with other information (e.g., wrapper format). Information defining visual content (visual information) may be stored within a single file or multiple files. For example, visual information defining an image or video frames of a video may be stored within a single file (e.g., image file, video file), multiple files (e.g., multiple image files, multiple video files), a combination of different files, and/or other files.

Visual information may define visual content by including information that defines one or more content, qualities, attributes, features, and/or other aspects of the visual content. For example, the visual information may define visual content of an image by including information that makes up the content of the image, and/or information that is used to determine the content of the image. For instance, the visual information may include information that makes up and/or is used to determine the arrangement of pixels, characteristics of pixels, values of pixels, and/or other aspects of pixels that define visual content of the image. For example, the visual information may include information that makes up and/or is used to determine pixels of the image. Other types of visual information are contemplated.

Capture of visual content by the image sensor 306 may include conversion of light received by the image sensor 306 into output signals/visual information defining visual content. Capturing visual content may include recording, storing, and/or otherwise capturing the visual content for use in generating video content (e.g., content of video frames). For example, during a capture duration, the visual output signal generated by the image sensor 306 and/or the visual information conveyed by the visual output signal may be used to record, store, and/or otherwise capture the visual content for use in generating video content.

In some implementations, the image capture device 302 may include multiple image sensors. For example, the image capture device 302 may include multiple image sensors carried by the housing 312 to capture spherical images/videos based on light guided thereto by multiple optical elements. For instance, the image capture device 302 may include two image sensors configured to receive light from two optical elements positioned on opposing sides of the housing 312. The fields of views of the optical elements may overlap and enable capture of spherical images and/or spherical videos.

The display 322 may refer to an electronic device for visually presenting information. The display 322 may include one or more screens. The display 322 may be used to present visual content (of images, of videos) captured by the image capture device 302. The display 322 may be used to present previews of visual content captured or to be captured by the image capture device 302. The display 312 may be used to present other visual information, such as settings for the image capture device 302 and/or messages (e.g., instructions, notices, warnings, alerts, reminders) for the user of the image capture device 302. In some implementations, the display 322 may include a touchscreen display. A touchscreen display may be configured to receive user input via user engagement with the touchscreen display. A user may engage with the touchscreen display via interaction with one or more touch-sensitive surfaces/screens and/or other components of the touchscreen display. A user may engage with the touchscreen display to provide input (e.g., command) to the image capture device 302.

The button 324 may refer to one or more mechanisms that may be physically interacted upon by a user. The button 324 may be interacted upon by a user to operate the button 324 and provide input (e.g., command) to the image capture device 302. For example, a user may interact with the button 324 to provide input/command to the image capture device 302 to turn on/power on the image capture device, turn off/power off the image capture device, capture videos, select a target, and/or to otherwise operate the image capture device. User interaction with the button 324 may include one or more of pressing the button 324, pulling the button 324, twisting the button 324, flipping the button 324, and/or other interaction with the button 324. The button 324 may include a dedicated button with the interaction of the button 324 causing specific operation/functionality (e.g., power button, record button). The button 324 may include a multi-purpose button with the interaction of the button 324 causing different operations/functionalities (e.g., based on different context in which the image capture device 302 is operating, based on user specifying the use of the button 324).

The processor 310 may include one or more processors (logic circuitry) that provide information processing capabilities in the image capture device 302. The processor 310 may provide one or more computing functions for the image capture device 302. The processor 310 may operate/send command signals to one or more components of the image capture device 302 to operate the image capture device 302. For example, the processor 310 may facilitate operation of the image capture device 302 in capturing image(s) and/or video(s), facilitate operation of the optical element 304 (e.g., change how light is guided by the optical element 304), and/or facilitate operation of the image sensor 306 (e.g., change how the received light is converted into information that defines images/videos and/or how the images/videos are post-processed after capture).

The processor 310 may obtain information from the image sensor 306 and/or other sensor(s), and/or facilitate transfer of information from the image sensor 306 and/or other sensor(s) to another device/component. The processor 310 may be remote from the processor 11 or local to the processor 11. One or more portions of the processor 310 may be part of the processor 11 and/or one or more portions of the processor 10 may be part of the processor 310. The processor 310 may include and/or perform one or more functionalities of the processor 11 shown in FIG. 1.

The image capture device 302 may capture visual content through the optical element 304 during a capture duration. The image capture device 302 may detect a target gesture within the visual content. The target gesture may identify a subject to be targeted by the image capture device 302 within the visual content. The target gesture may indicate to the image capture device 302 which object depicted within the visual content/which portion of the visual content should be targeted by the image capture device 302 for future capture of the visual content. For instance, the subject identified by the target gesture may be used by the image capture device 302 as a focus target and/or a stabilization target in future capture of the visual content. Responsive to detection of the target gesture within the visual content, the image capture device 302 may change its targeting to be directed at the subject identified by the target gesture.

Change in targeting may include setting or altering the targeting of the image capture device. For instance, the target of the image capture device 302 may not have been previously set, and change in targeting of the image capture device 302 may include using the subject as the target of the image capture device 302. The target of the image capture device 302 may have been previously set, and change in targeting of the image capture device 302 may include switching the target so that the subject identified by the target gesture is the new target of the image capture device 302.

The image capture device 302 may persistently target the subject identified by the target gesture for future capture of the visual content. The target gesture may initialize the targeting control of the image capture device 302 to be pointed at the subject identified by the target gesture. When the user's hand is taken out of the field of view of the image capture device 302, the image capture device 302 may continue to target the subject. The image capture device 302 may continue to automatically target the subject for future capture of the visual content. For instance, after the user's hand is taken away, the subject identified by the target gesture may continue to be automatically targeted for focusing and/or stabilization by the image capture device 302.

Referring back to FIG. 1, the processor 11 (or one or more components of the processor 11) may be configured to obtain information to facilitate changing operation of image capture device based on lens cover usage. Obtaining information may include one or more of accessing, acquiring, analyzing, determining, examining, identifying, loading, locating, opening, receiving, retrieving, reviewing, selecting, storing, and/or otherwise obtaining the information. The processor 11 may obtain information from one or more locations. For example, the processor 11 may obtain information from a storage location, such as the electronic storage 13, electronic storage of information and/or signals generated by one or more sensors, electronic storage of a device accessible via a network, and/or other locations. The processor 11 may obtain information from one or more hardware components (e.g., an image sensor) and/or one or more software components (e.g., software running on a computing device).

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate changing targeting of an image capture device based on gestures. The machine-readable instructions 100 may include one or more computer program components. The machine-readable instructions 100 may include one or more of a capture component 102, a target gesture component 104, a target component 106, and/or other computer program components.

The capture component 102 may be configured to capture the visual content. The visual content may be captured during one or more capture durations. The visual content may be captured through one or more optical elements. For example, referring to FIG. 3, the visual content may be captured through the optical element 304. A capture duration may refer to a time duration in which visual content is captured. Capturing visual content during a capture duration may include recording, storing, and/or otherwise capturing the visual content during the capture duration. The visual content may be captured for use in generating images and/or video frames. The visual content may be captured for use in detecting a target gesture to changing target of the image capture device.

For example, during a capture duration, the capture component 102 may use the visual output signal generated by an image sensor (e.g., the image sensor 306) and/or the visual information conveyed by the visual output signal to record, store, and/or otherwise capture the visual content. For instance, the capture component 102 may store, in the electronic storage 13 and/or other (permanent and/or temporary) electronic storage medium, information (e.g., the visual information) defining the visual content based on the visual output signal generated by the image sensor and/or the visual information conveyed by the visual output signal during the capture duration. In some implementations, information defining the captured visual content may be stored in one or more visual tracks. In some implementations, the information defining the visual content may be discarded. For instance, the visual information defining the visual content may be temporarily stored for use in detecting a target gesture within the visual content, and the visual information may be deleted after the detection.

The target gesture component 104 may be configured to detect a target gesture within the visual content. Detecting a target gesture within the visual content may include one or more of determining, discerning, discovering, finding, identifying, spotting, and/or otherwise detecting the target gesture within the visual content. The target gesture within the visual content may be detected based on analysis of the visual content and/or other information. Analysis of the visual content may include examination, evaluation, processing, studying, and/or other analysis of the visual content. For example, analysis of the visual content may include examination, evaluation, processing, studying, and/or other analysis of one or more visual features/characteristics of the visual content. Analysis of the visual content may include analysis of visual content of a single image/video frame and/or analysis of visual content of multiple images/video frames. For example, visual features and/or visual characteristics of a single image may be analyzed to determine whether a target gesture is depicted within the visual content. Visual features and/or visual characteristics of multiple images (e.g., captured at different moment, captured over a duration of time) may be analyzed to determine whether a target gesture is depicted within the visual content. In some implementations, the target gesture component 104 may utilize computer vision, object/pattern recognition, object/pattern tracking, and/or other visual analysis to detect a target gesture within the visual content.

A target gesture may refer to a shape made by one or more fingers, one or more hands, and/or other body parts/tools. A target gesture may refer to a movement of one or more fingers, one or more hands, and/or other body parts/tools. For example, a target gesture may include a particular way in which finger(s)/hand(s)/tool(s) are held and/or moved. A target gesture may be static or dynamic. A target gesture may convey information using the shape/movement.

A target gesture may identify a subject to be targeted by the image capture device within the visual content. A target gesture may identify a subject within the visual content that is to be used by the image capture device as a target for future capture of the visual content. A subject may refer to a living and/or a non-living thing depicted within the visual content. For example, a target gesture may identify which thing(s) depicted within the visual content is to be targeted by the image capture device (e.g., stabilization target, focus target). A subject may refer to a portion (an extent) of the visual content. For example, a target gesture may identify which portion/extent of the visual content should be used by the image capture device as the target for image capture device operation (e.g., stabilization, focus).

A target gesture may identify a subject to be targeted by the image capture device by pointing at the subject, pointing to the subject, enclosing/surrounding the subject, isolating the subject, and/or otherwise identifying the subject. A target gesture may identify the subject based on the shape made by one or more fingers, one or more hands, and/or other body parts/tools. A target gesture may identify the subject based on the movement of one or more fingers, one or more hands, and/or other body parts/tools. A target gesture may identify the subject based on a direction, an area, and/or other information indicated by the target gesture. In some implementations, object classification, saliency detection, and/or other visual analysis technique may be used to identify the subject based on the target gesture. For example, object classification and/or saliency detection may be used to identify a subject that may be of most interest to the user (e.g., face, person, emotion, action) to target when capturing visual content.

In some implementations, the target gesture within the visual content may be detected based on activation of a gesture target mode of the image capture device and/or other information. A gesture target mode of the image capture device may refer to a mode of operation in which target for the image capture device is selected using a target gesture detected within the visual content. A gesture target mode of the image capture device may be activated by default or based on user activation of the mode. For example, a gesture target mode of the image capture device may be activated based on a user's physical interaction with the image capture device (e.g., physical interaction with the button 324, the display 322), a user's verbal interaction with the image capture device (e.g., user turning on the gesture target mode via voice activation, such as a user stating, “Gesture Mode On”), and/or other interaction of a user with the image capture device.

In some implementations, the target gesture may include one or more pointing fingers. A pointing finger may refer to a finger extend in a direction. A pointing figure may include a finger in an extended position, with the finger pointed in a direction. The subject may be identified based on a direction in which the pointing finger(s) are pointed. The subject may be identified at the tip of the pointing finger(s) and/or along the direction in which the pointing finger(s) are pointed.

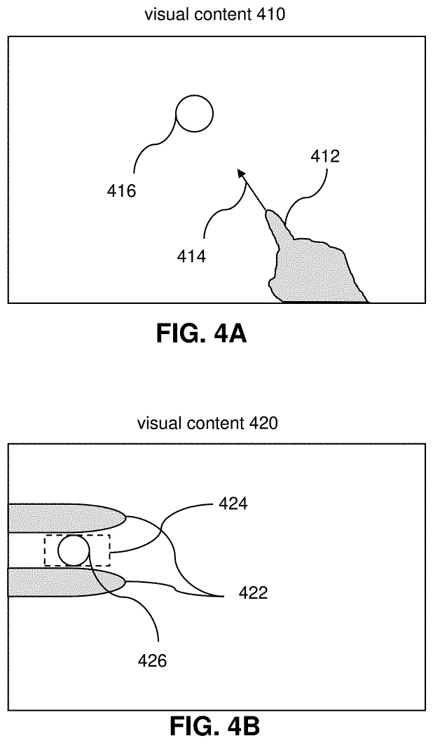

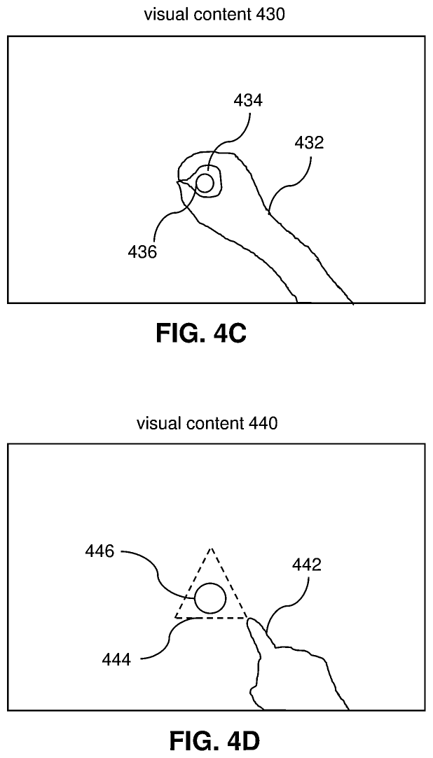

For example, FIG. 4A illustrates an example target gesture 412. The target gesture 412 may be captured within (depicted within) visual content 410 captured by an image capture device. The target gesture 412 may include a pointing finger (e.g., index finger), which is pointed in a direction 414. A subject 416 may be identified by the target gesture 412 based on the direction 414 in which the pointing finger is pointed. In some implementations, the direction 414 may be determined based on analysis of the geometry of the pointing finger within one or more images/video frames. In some implementations, the direction 414 may be adjusted based on how the image capture device is being carried during capture of the visual content 410. For example, the direction 414 may be adjusted based on whether the image capture device is mounted on a person's head, chin, chest, shoulder, and/or other positions. The adjustment may take in account differences between the point of view of the user and the point of view of the image capture device to determine where the user is pointing with the gesture 414. Other identification of subjects using pointing finger(s) are contemplated.

In some implementations, the target gesture may include bounding fingers. Bounding fingers may refer to finger that bound an area (e.g., portion of the visual content). Bounding fingers may partially or totally bound the area. Bounding fingers may include two or more fingers extended while distanced apart to creating a bounding area. Bounding fingers may include fingers of one hand or two hands. For example, bounding fingers may include two fingers of one hand separated to create a bounding area near the tips of the fingers. Bounding fingers may include two separated fingers of one hand and two separate fingers of other hand crossed to create a bounding area (quadrilateral area) between the fingers. The subject may be identified based on a portion of the visual content bounded by the bounding fingers. The subject may be identified as the bounded portion and/or within the bounded portion.

For example, FIG. 4B illustrates an example target gesture 422. The target gesture 422 may be captured within (depicted within) visual content 420 captured by an image capture device. The target gesture 422 may include two fingers extended in parallel and separated by a distance to create a bounding area 424. The bounding area 424 may cover a portion of the visual content 420. A subject 426 may be identified by the target gesture 422 based the portion of the visual content 420 bounded by the bounding fingers. The subject 426 may be identified to include the bounded portion and/or based on analysis of the visual content 420 within the bounded portion.

FIG. 4C illustrates an example target gesture 432. The target gesture 432 may be captured within (depicted within) visual content 430 captured by an image capture device. The target gesture 432 may include fingers in a circled position to create a bounding area within the fingers. The bounding area may cover a portion of the visual content 430. A subject 436 may be identified by the target gesture 432 based the portion of the visual content 330 bounded by the bounding fingers. The subject 436 may be identified to include the bounded portion and/or based on analysis of the visual content 430 within the bounded portion. Other identification of subjects using bounding fingers are contemplated.

In some implementations, the target gesture includes movement of one or more fingers to trace a shape. Movement of a finger may include change in position of the finger over time. Movement of finger(s) may be captured within the visual content over a duration (over multiple images, video frames). The subject may be identified based on a portion of the visual content bounded by the shape. The subject may be identified as the bounded portion and/or within the bounded portion.

For example, FIG. 4D illustrates an example target gesture 442. The target gesture 442 may be captured within (depicted within) visual content 440 captured by an image capture device. The target gesture 432 may include movement of a finger (e.g., index finger) to trace a shape 444. The shape 444 may cover a portion of the visual conte3nt 440. A subject 446 may be identified by the target gesture 442 based on the portion of the visual content 440 bounded by the shape 444. The subject 446 may be identified to include the bounded portion and/or based on analysis of the visual content 440 within the bounded portion. Other identification of subjects using movement of finger(s) are contemplated.

The target component 106 may be configured to, responsive to detection of the target gesture within the visual content, change targeting of the image capture device for future capture of the visual content. The targeting of the image capture device may be changed to be directed at the subject identified by the target gesture. Changing targeting of the image capture device for future capture of the visual content may include changing subject that is targeted by the image capture device for future capture of the visual content. The target component 106 may change targeting of the image capture device by setting or altering the targeting of the image capture device. For example, the image capture device may not be targeting any subject in capture of visual content, and the target component 106 may cause the image capture device to set a subject as the target. The image capture device may be targeting a subject in capture of visual content, and the target component 106 may cause the image capture device to switch the targeting so that a different subject is targeted by the image capture device.

The image capture device may persistently target the subject identified by the target gesture for future capture of the visual content. The target gesture may prompt the image capture device to initialize its targeting control to be pointed at the subject identified by the target gesture. The image capture device may automatically and continually target the subject identified by the target gesture until targeting control is changed (e.g., via another target gesture, via user interaction with the image capture device), until targeting control is canceled/deactivated, and/or until targeting of the subject is no longer possible (e.g., the subject moves out of the field of view of the image capture device for a threshold amount of time; the image capture device is not able to maintain targeting of the subject). Thus, the image capture device may automatically target the subject manually selected via the target gesture.

Use of target gesture to identify the subject to be targeted by the image capture device may allow for the targeting of the image capture device to be changed without physical interaction of a user with the image capture device. Physical interaction of the user with the image capture device may refer to the user physically engaging with the image capture device, such as pressing a button or touching a touchscreen display of the image capture device. That is, targeting of the image capture device may be changed without the user physically interacting with the image capture device to change the targeting. Such change in the targeting of the image capture device may be more intuitive, easier, and/or faster than requiring physical interaction with the image capture device. Such change in the targeting of the image capture device may provide user with control over targeting without causing undesired movement of the image capture device (e.g., bump of the image capture device when pressing a button, the image capture device being dislodge from its position when touching a touchscreen display).

Use of target gesture to identify the subject to be targeted by the image capture device may allow for the targeting of the image capture device to be changed without having physical access/view of the image capture device. For example, mounting the image capture device on the head, shoulder, or chest of a user may make it difficult/impossible to reach image capture device controls, such as those presented on the display(s) of the image capture device. A user may control targeting of the image capture device through target gesture even when display(s)/button(s) of the image capture device are not readily accessible.

Use of target gesture to identify the subject to be targeted by the image capture device may allow for the targeting of the image capture device to be changed through hand gestures made by multiple people. For example, a user of a chest-mounted image capture device may wish to target a particular person. The user may move the image capture device to bring the person within the field of view of the image capture device and/or have the person move into the field of view of the image capture device. The targeting of the image capture device may be initialized to be centered on the person based on target gesture made by the user or the person (or some other party). For instance, when the person is in front of the image capture device, the user may point a finger at the person to direct the image capture device to automatically and continually target the person. When the person is in front of the image capture device, the person may point the finger at himself to direct the image capture device to automatically and continually target the person.

In some implementations, the change in the targeting of the image capture device for future capture of the visual content to be directed at the subject identified by the target gesture may include setting the subject identified by the target gesture as a stabilization target for the future capture of the visual content. A stabilization target may refer to a target that is to be stabilized within the visual content. A stabilization target may refer to a target that is used to position stabilization crop/punchout/viewing window to generate stabilized visual content. Which subject is used to stabilize the visual content may be determined based on the target gesture/subject identified by the target gesture. For instance, based on the target gesture identifying an object of interest (e.g., face) within the visual content, the stabilization of the visual content may be changed to follow the object of interest, such as by centering the object of interest within the stabilization crop/punchout/viewing window. Other use of stabilization target are contemplated.

In some implementations, the change in the targeting of the image capture device for future capture of the visual content to be directed at the subject identified by the target gesture may include setting the subject identified by the target gesture as a focus target for the future capture of the visual content. A focus target may refer to a target that is used to control focusing of the image capture device. A focus target may refer to a target that is desired to be depicted sharply within the visual content. Which subject is sued to focus the image capture device may be determined based on the target gesture/subject identified by the target gesture. For instance, based on the target gesture identifying a thing depicted within the visual content, the focusing of the image capture device may be changed to increase (e.g., maximize) sharpness of the thing within the visual content. Other use of focus target are contemplated.

In some implementations, the image capture device may further comprise a display. A preview of the change in the targeting of the image capture device for future capture of the visual content to be directed at the subject identified by the target gesture may be presented on the display prior to the change in the targeting of the image capture device. That is, before the subject identified by the target gesture is targeted by the image capture device, the image capture device may provide information on the display regarding the targeting to be changed based on the target gesture. For example, the display may provide a message stating that the target of the image capture device will be changed. The display may provide a message stating that the target of the image capture device will be changed to the subject identified by the target gesture. The display may provide a preview of the visual content, and use one of more visual elements to indicate/emphasize the subject identified by the target gesture (e.g., placing brackets around the subject, coloring the subject differently from rest of the visual content). For instance, a region of interest identified based on the target gesture may be highlighted within the preview of the visual content.

In some implementations, cancellation of the change in the targeting of the image capture device for future capture of the visual content to be directed at the subject identified by the target gesture may be receivable via user interaction with the image capture device. That is, the change in targeting of the image capture device prompted by the target gesture may be canceled before the change takes place. User interaction with the image capture device to cancel the change in targeting of the image capture device may include physical interaction with the image capture device (e.g., pressing a button, the touching a touchscreen display) and/or a non-physical interaction with the image capture device (e.g., voice command, making a gesture in front of the image capture device that is interpreted as command to cancel the target change).

In some implementation, the targeting of the image capture device may be canceled/deactivated based on changes in the scene captured by the image capture devices and/or other information. Changes in the scene captured by the image capture device may be determined based on analysis of the visual content captured by the image capture device, movement of the image capture device, and/or other information. Changes in the scene captured by the image capture device may result in the subject identified by the target gesture no longer being captured by the image capture device (being outside the field of view of the image capture device).

In some implementations, the targeting of the image capture device may be canceled/deactivated based on user input and/or other information. User input may direct the image capture device to stop targeting of the subject identified by the target gesture. User input may be received via user interaction with the image capture device. User input may be received via voice command. User input may be received via a gesture captured within the visual content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible (non-transitory) machine-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11 and the electronic storage 13 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, Li-Fi communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer components are illustrated in FIG. 1 as being co-located within a single processing unit, in implementations in which processor 11 comprises multiple processing units, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

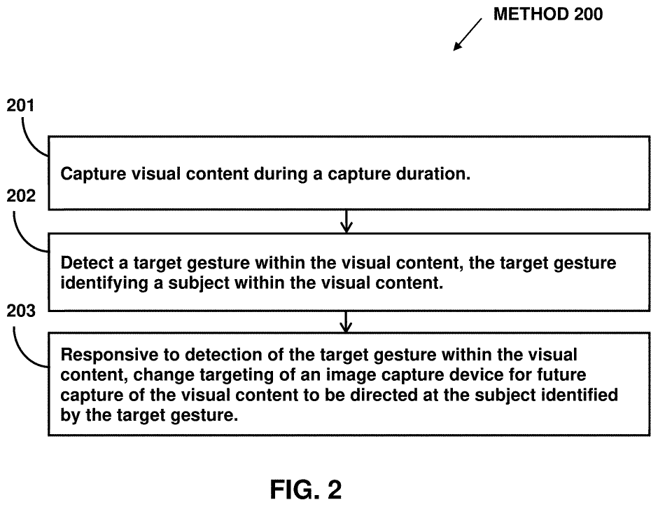

FIG. 2 illustrates method 200 for changing targeting of an image capture device based on gestures. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 201, visual content may be captured during a capture duration. In some implementation, operation 201 may be performed by a processor component the same as or similar to the capture component 102 (Shown in FIG. 1 and described herein).

At operation 202, a target gesture may be detected within the visual content. The target gesture may identify a subject to be targeted by the image capture device within the visual content. In some implementation, operation 202 may be performed by a processor component the same as or similar to the target gesture component 104 (Shown in FIG. 1 and described herein).

At operation 203, responsive to detection of the target gesture within the visual content, targeting of the image capture device for future capture of the visual content may be changed to be directed at the subject identified by the target gesture. In some implementation, operation 203 may be performed by a processor component the same as or similar to the target component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. An image capture device for changing targeting based on gestures, the image capture device comprising:
a housing;
a display carried by the housing;
an image sensor carried by the housing and configured to generate a visual output signal conveying visual information based on light that becomes incident thereon, the visual information defining visual content;
an optical element carried by the housing and configured to guide light within a field of view to the image sensor; and
one or more physical processors carried by the housing, the one or more physical processors configured by machine-readable instructions to:
capture the visual content during a capture duration;
detect a target gesture within the visual content, the target gesture identifying a subject to be targeted by the image capture device within the visual content; and
responsive to detection of the target gesture within the visual, content:
before changing targeting of the image capture device for future capture of the visual content to be directed at the subject identified by the target gesture, present a preview on the display of the change in the targeting of the image capture device for future capture of the visual content to be directed at the subject identified by the target gesture; and
change the targeting of the image capture device for future capture of the visual content to be directed at the subject identified by the target gesture.

2. The image capture device of claim 1, wherein the change in the targeting of the image capture device for future capture of the visual content to be directed at the subject identified by the target gesture includes setting the subject identified by the target gesture as a stabilization target for the future capture of the visual content.

3. The image capture device of claim 1, wherein the change in the targeting of the image capture device for future capture of the visual content to be directed at the subject identified by the target gesture includes setting the subject identified by the target gesture as a focus target for the future capture of the visual content.

4. The image capture device of claim 1, wherein:
the target gesture includes one or more pointing fingers; and
the subject is identified based on a direction in which the one or more pointing fingers are pointed.

5. The image capture device of claim 1, wherein:
the target gesture includes bounding fingers; and
the subject is identified based on a portion of the visual content bounded by the bounding fingers.

6. The image capture device of claim 1, wherein:
the target gesture includes movement of a finger to trace a shape; and
the subject is identified based on a portion of the visual content bounded by the shape.

7. The image capture device of claim 1, wherein the target gesture within the visual content is detected based on voice activation of a gesture target mode of the image capture device.

8. The image capture device of claim 1, wherein:
the preview of the change in the targeting of the image capture device for future capture of the visual content to be directed at the subject identified by the target gesture presented on the display prior to the change in the targeting of the image capture device includes a message stating that the targeting of the image capture device will be changed.

9. The image capture device of claim 8, wherein cancellation of the change in the targeting of the image capture device for future capture of the visual content to be directed at the subject identified by the target gesture is receivable via user interaction with the image capture device before the targeting of the image capture device for future capture of the visual content is changed to be directed at the subject identified by the target gesture to enable cancellation of the change in the targeting of the image capture device for future capture of the visual content before the change in the targeting of the image capture device for future capture of the visual content is made.

10. (canceled)

11. A method for changing targeting of an image capture device based on gestures, the image capture device including a display, an optical element, an image sensor, and one or more processors, the optical element configured to guide light within a field of view to the image sensor, the image sensor configured to generate a visual output signal conveying visual information based on light that becomes incident thereon, the visual information defining visual content, the method comprising:
capturing, by the one or more processors, the visual content during a capture duration;
detecting, by the one or more processors, a target gesture within the visual content, the target gesture identifying a subject to be targeted by the image capture device within the visual content; and
responsive to detection of the target gesture within the visual content:
before changing targeting of the image capture device for future capture of the visual content to be directed at the subject identified by the target gesture, presenting, by the one or more processors, a preview on the display of the change in the targeting of the image capture device for future capture of the visual content to be directed at the subject identified by the target gesture; and
changing, by the one or more processors, the targeting of the image capture device for future capture of the visual content to be directed at the subject identified by the target gesture.

12. The method of claim 11, wherein the change in the targeting of the image capture device for future capture of the visual content to be directed at the subject identified by the target gesture includes setting the subject identified by the target gesture as a stabilization target for the future capture of the visual content.

13. The method of claim 11, wherein the change in the targeting of the image capture device for future capture of the visual content to be directed at the subject identified by the target gesture includes setting the subject identified by the target gesture as a focus target for the future capture of the visual content.

14. The method of claim 11, wherein:
the target gesture includes one or more pointing fingers; and
the subject is identified based on a direction in which the one or more pointing fingers are pointed.

15. The method of claim 11, wherein:
the target gesture includes bounding fingers; and
the subject is identified based on a portion of the visual content bounded by the bounding fingers.

16. The method of claim 11, wherein:
the target gesture includes movement of a finger to trace a shape; and
the subject is identified based on a portion of the visual content bounded by the shape.

17. The method of claim 11, wherein the target gesture within the visual content is detected based on voice activation of a gesture target mode of the image capture device.

18. The method of claim 11, wherein:
the preview of the change in the targeting of the image capture device for future capture of the visual content to be directed at the subject identified by the target gesture presented on the display prior to the change in the targeting of the image capture device includes a message stating that the targeting of the image capture device will be changed.

19. The method of claim 18, wherein cancellation of the change in the targeting of the image capture device for future capture of the visual content to be directed at the subject identified by the target gesture is receivable via user interaction with the image capture device before the targeting of the image capture device for future capture of the visual content is changed to be directed at the subject identified by the target gesture to enable cancellation of the change in the targeting of the image capture device for future capture of the visual content before the change in the targeting of the image capture device for future capture of the visual content is made.

20. (canceled)

21. The image capture device of claim 1, wherein:
the preview of the change in the targeting of the image capture device for future capture of the visual content to be directed at the subject identified by the target gesture presented on the display prior to the change in the targeting of the image capture device includes the preview presented on the display including a visual element that indicates the subject identified by the target gesture.

22. The image capture device of claim 1, wherein the change in the targeting of the image capture device for future capture of the visual content is cancelled based on a change in a scene captured by the image capture device.
